(19) United States
(12) Patent Application Publication
(10) Pub. No.: US 2026/0161597 A1
(43) Pub. Date: Jun. 11, 2026

(54) Crystal-less Universal Serial Bus Device and Clock Signal Generating Method

(71) Applicant: NOVATEK Microelectronics Corp., Hsin-Chu (TW)

(72) Inventors: Chih-Yuan Kung, Kaohsiung City (TW); Yi-Cheng Liu, Tainan City (TW); Ruo-Yang Lee, Kaohsiung City (TW); Bing-Syun Wu, Hsinchu County (TW)

(73) Assignee: NOVATEK Microelectronics Corp., Hsin-Chu (TW)

(21) Appl. No.: 18/970,959

(22) Filed: Dec. 6, 2024

(51) Int. Cl. G06F 13/42; G06F 13/38

(52) U.S. Cl. CPC G06F 13/4282; G06F 13/382; G06F 2213/0042

(57) ABSTRACT

A universal serial bus (USB) device, coupled to a USB host, includes a transceiver, receiving a data signal having a first frequency from the USB host, wherein the data signal comprises a plurality of specific packets with a periodic characteristic; a packet detector, coupled to the transceiver, receiving the data signal through the transceiver, configured to generate a reference signal according to the periodic characteristic of the plurality of specific packets; and a frequency-locked loop (FLL) circuit, coupled to the transceiver and the packet detector, configured to generate a clock signal having a second frequency according to the reference signal; wherein the first frequency is substantially equal to the second frequency. In other words, the second frequency is adjusted to approach the first frequency, and a frequency difference between the first frequency and the second frequency is smaller than 500 ppm.

### BACKGROUND OF THE INVENTION

### 1. Field of the Invention

The present invention relates to a universal serial bus device and clock signal generating method, and more specifically, to a crystal-less universal serial bus device and clock signal generating method.

### 2. Description of the Prior Art

In the USB protocol, hardware operates in master and slave modes, categorizing it into USB Hosts and USB Devices. A USB Host may connect to multiple USB Devices and controls communication. The USB Devices may be common mobile devices, such as mobile phones, mobile hard drives, etc. The USB Devices require external components, such as quartz oscillators, to generate accurate clocks necessary for meeting the USB specification. These components not only add to the cost but also necessitate additional pins for receiving clock signals, further increasing expenses.

If the external components are eliminated and the internal oscillator of the USB device is used instead, the oscillator operates in an open-loop configuration, making it susceptible to variations in process, voltage and temperature. Consequently, the frequency error between the USB Device's clock signal and the USB Host's clock signal can reach 200,000-300,000ppm, significantly exceeding the 500 ppm limit set by the USB specification. Thus, there is a need for improvement over the prior art.

### SUMMARY OF THE INVENTION

It is therefore an objective of the present invention to provide a universal serial bus device and clock signal generating method, so as to improve the frequency error between a clock signal of the USB device and a clock signal of the USB host.

An embodiment of the present invention discloses a universal serial bus (USB) device, coupled to a USB host. The USB device comprises a transceiver, receiving a data signal having a first frequency from the USB host, wherein the data signal comprises a plurality of specific packets with a periodic characteristic; a packet detector, coupled to the transceiver, receiving the data signal through the transceiver, configured to generate a reference signal according to the periodic characteristic of the plurality of specific packets; and a frequency-locked loop (FLL) circuit, coupled to the transceiver and the packet detector, configured to generate a clock signal having a second frequency according to the reference signal; wherein the first frequency is substantially equal to the second frequency. In other words, the second frequency is adjusted to approach the first frequency, and a frequency difference between the first frequency and the second frequency is smaller than 500 ppm.

An embodiment of the present invention discloses a clock signal generating method, applied in a universal serial bus (USB) device coupled to a USB host. The clock signal generating method comprises receiving, by a transceiver of the USB device, a data signal having a first frequency from the USB host, wherein the data signal comprises a plurality of specific packets with a periodic characteristic; generating, by a packet detector of the USB device, a reference signal according to the periodic characteristic of the plurality of specific packets; and generating, by a frequency-locked loop (FLL) circuit of the USB device, a clock signal having a second frequency according to the reference signal; wherein the first frequency is substantially equal to the second frequency. In other words, the second frequency is adjusted to approach the first frequency, and a frequency difference between the first frequency and the second frequency is smaller than 500 ppm.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a universal serial bus system according to an embodiment of the present invention.

FIG. 2 is a schematic diagram of the plurality of SOF packets according to an embodiment of the present invention.

FIG. 3 is a schematic diagram of a digital phase-locked loop circuit according to an embodiment of the present invention.

FIG. 4 is a time domain waveform diagram of the digital phase locked loop circuit according to the embodiment of the present invention.

### DETAILED DESCRIPTION

Certain terms are used throughout the description and following claims to refer to specific components. As one skilled in the art will appreciate, hardware manufacturers may refer to a component by different names. This document does not intend to distinguish between components that differ in name but not function. In the following description and in the claims, the terms “include” and “comprise” are utilized in an open-ended fashion, and thus should be interpreted to mean “include, but not limited to”. Also, the term “couple” is intended to mean either an indirect or direct electrical connection. Accordingly, if one device is coupled to another device, that connection may be through a direct electrical connection, or through an indirect electrical connection via other devices and connections.

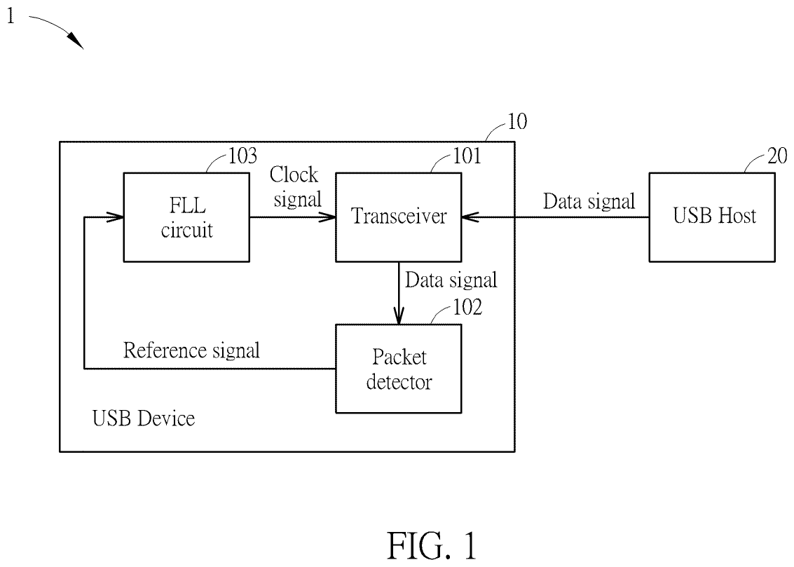

Please refer to FIG. 1. FIG. 1 is a schematic diagram of a universal serial bus (USB) system 1 according to an embodiment of the present invention. The USB system 1 includes a USB device 10 and a USB host 20 coupled to each other. The USB device 10 may receive a data signal from the USB host 20 and perform a clock signal generating method to generate a clock signal corresponding to the data signal. In detail, the USB device 10 includes a transceiver 101, a packet detector 102 and a frequency-lock-loop (FLL) circuit 103. The transceiver 101 may receive the data signal having a first frequency from the USB host 20. It should be noted that the data signal transmitted by the USB host 20 may include a plurality of packets, and the plurality of packets may include a plurality of specific packets with a periodic characteristic. When the transceiver 101 receives the data signal, the data packet detector 102 may receive the data signal and generate a reference signal according to the periodic characteristic of the plurality of specific packets. The FLL circuit 103 then generates the clock signal with a second frequency according to the reference signal, and provides the clock signal to the transceiver 101 to process the data signal. In this way, the clock signal generating method of the present invention may make the second frequency be substantially equal to the first frequency; that is, the second frequency is adjusted to approach the first frequency, and the frequency difference between the first frequency and the second frequency may be less than the 500 ppm required by the USB specification.

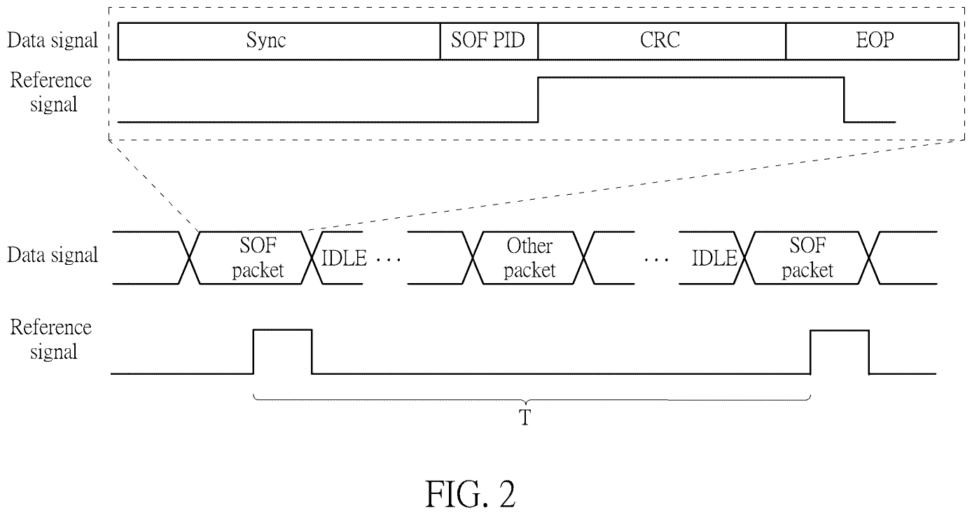

It should be noted that the USB system 1 is an embodiment of the present invention, and those skilled in the art may make appropriate adjustments according to the system requirements. For example, the USB specification defines that the data signal includes a variety of packets such as start-of-frame (SOF) packets, wherein the USB device uses SOF packets to determine the starting point of the frame in the data signal, i.e., in this embodiment of the present invention, a plurality of specific packets with a periodic characteristic may be a plurality of SOF packets, but not limited thereto. In other words, in the embodiment of the present invention, a plurality of specific packets with periodic characteristics may be a plurality of SOF packets, but is not limited thereto. Please refer to FIG. 2, which is a schematic diagram of the plurality of SOF packets according to an embodiment of the present invention. As shown in FIG. 2, the data signal includes the plurality of SOF packets and other packets. In the data signal, the SOF packets appear once at a fixed time interval T. In this way, the packet detector 102 of the present invention may detect the occurrence of SOF packets and generate a reference signal with a period of the fixed time interval T accordingly. Specifically, each SOF packet includes a SYNC field, a packet identifier (PID) field, a CRC field, and an EOP field. When the packet detector 102 detects [01011010] in the PID field, the packet detector 102 may determine that the packet is a SOF packet, i.e. the PID field corresponding to the SOF packet, and generate a reference signal accordingly. It should be noted that the packet detector 102 may be composed of various types of logic gates, and the operation principle of the logic gates is well known in the art and will not be repeated hereinafter. In addition, the operation of SOF packets, SETUP packets, IN packets, OUT packets, and the corresponding SYNC, PID, CRC, and EOP fields of the above packets are well known in the art and will not be repeated hereinafter. For example, the PID field for the SETUP packet is [11010010], the PID field for the IN packet is [10010110], and the PID field for the OUT packet is [00011110].

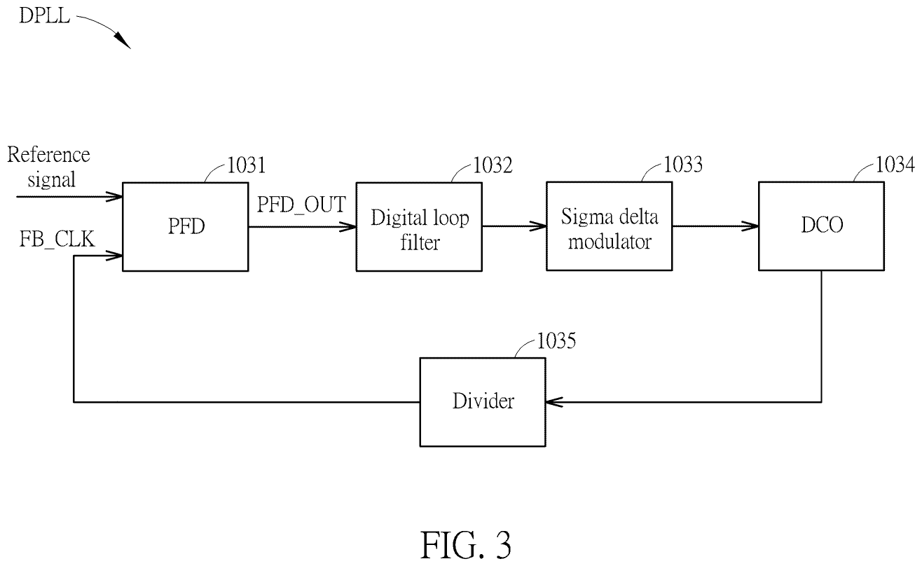

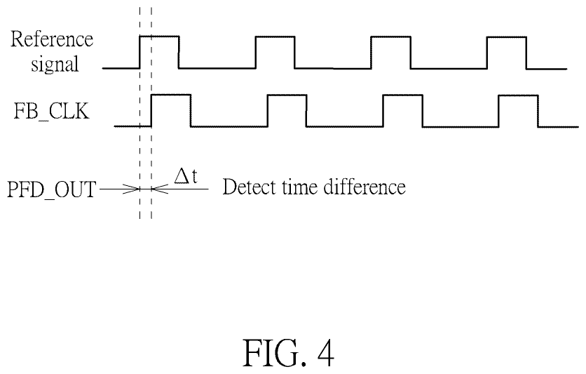

On the other hand, the FLL circuit 103 of the present invention may be a phase-locked-loop (PLL) circuit, a digital PLL (DPLL) circuit, or a clock and data recovery (CDR) circuit, but is not limited thereto. In an embodiment, please refer to FIG. 3, which is a schematic diagram of a digital phase-locked loop circuit DPLL according to an embodiment of the present invention. In the embodiment, the digital phase-locked loop DPLL comprises a phase-frequency detector (PFD) 1031, a digital loop filter 1032, a sigma-delta modulator 1033, a digital control oscillator (DCO) 1034, and a divider 1035. Specifically, the phase frequency detector 1031 is configured to determine the frequency phase difference between the reference signal and a feedback signal FB_CLK. The digital loop filter 1032 is configured to remove noise from the frequency phase difference. The sigma-delta modulator 1033 is configured to eliminate the quantization error of the frequency phase difference. In this way, the frequency phase difference may be used to control the digital control oscillator 1034 to generate a target clock signal. The divider 1035 is configured to divide the target clock signal to generate the feedback signal FB_CLK. In this embodiment, please refer to FIG. 4. FIG. 4 is a time domain waveform diagram of the digital phase locked loop circuit DPLL according to the embodiment of the present invention. As shown in FIG. 4, an output signal PFD_OUT of the phase frequency detector 1031 is the phase difference Δt between the reference signal and the feedback signal FB_CLK. The digital controlled oscillator 1034 responds to the phase difference Δt to generate the target clock signal. In this way, the digital phase locked loop circuit DPLL can continuously compare the feedback signal FB_CLK and the reference signal, so that the phases of the feedback signal FB_CLK and the reference signal are aligned. It should be noted that when the feedback signal FB_CLK is aligned with the reference signal, the target clock signal is the clock signal with the second frequency. In addition, the second frequency of the clock signal is substantially equal to the first frequency of the data signal, i.e., the frequency difference between the first frequency and the second frequency will be less than the 500 ppm required by the USB specification.

In summary, the USB device of the present invention is capable of detecting the plurality of specific packets with the periodic characteristic in the data signal and generating a clock signal accordingly. In this way, compared with the prior art, the USB device of the present invention may achieve the clock accuracy required by the USB specification without the use of external components (e.g., quartz oscillators).

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A universal serial bus (USB) device, coupled to a USB host, the USB device comprising:
a transceiver, receiving a data signal having a first frequency from the USB host, wherein the data signal comprises a plurality of specific packets with a periodic characteristic;
a packet detector, coupled to the transceiver, receiving the data signal through the transceiver, configured to generate a reference signal according to the periodic characteristic of the plurality of specific packets; and
a frequency-locked loop (FLL) circuit, coupled to the transceiver and the packet detector, configured to generate a clock signal having a second frequency according to the reference signal;
wherein the first frequency is substantially equal to the second frequency.

2. The USB device of claim 1, wherein the plurality of specific packets are a plurality of start-of-frame (SOF) packets.

3. The USB device of claim 2, wherein each of the plurality of SOF packets comprises a SOF packet identifier (PID), and the packet detector detects a time interval between the SOF PIDs corresponding to two adjacent SOF packets to generate the reference signal.

4. The USB device of claim 1, wherein a frequency difference between the first frequency and the second frequency is smaller than 500 ppm.

5. The USB device of claim 1, wherein the FLL circuit comprises a phase-locked loop circuit or a clock and data recovery circuit.

6. A clock signal generating method, applied in a universal serial bus (USB) device coupled to a USB host, the clock signal generating method comprising:
receiving, by a transceiver of the USB device, a data signal having a first frequency from the USB host, wherein the data signal comprises a plurality of specific packets with a periodic characteristic;
generating, by a packet detector of the USB device, a reference signal according to the periodic characteristic of the plurality of specific packets; and
generating, by a frequency-locked loop (FLL) circuit of the USB device, a clock signal having a second frequency according to the reference signal;
wherein the first frequency is substantially equal to the second frequency.

7. The clock signal generating method of claim 6, wherein the plurality of specific packets are a plurality of start-of-frame (SOF) packets.

8. The clock signal generating method of claim 7, wherein each of the plurality of SOF packets comprises a SOF packet identifier (PID), and the step of generating the reference signal according to the periodic characteristic of the plurality of specific packets comprises detecting a time interval between the SOF PIDs corresponding to two adjacent SOF packets to generate the reference signal.

9. The clock signal generating method of claim 6, wherein a frequency difference between the first frequency and the second frequency is smaller than 500 ppm.

10. The clock signal generating method of claim 6, wherein the FLL circuit comprises a phase-locked loop circuit or a clock and data recovery circuit.
